(19) United States
(12) Patent Application Publication
(10) Pub. No.: US 2026/0004684 A1
(43) Pub. Date: Jan. 1, 2026

(54) THERMAL MANAGEMENT IN WEARABLE DEVICES

(71) Applicant: QUALCOMM Incorporated, San Diego, CA (US)

(72) Inventors: Shruti HANUMANTHAIAH, Bangalore (IN); Subbarao LANKA, Bangalore (IN); Louis LOUIE, San Diego, CA (US); Simon Peter William BOOTH, San Diego, CA (US); Karthik RANGARAJU, San Diego, CA (US)

(21) Appl. No.: 18/992,505

(22) PCT Filed: Dec. 23, 2022
(86) PCT No.: PCT/US2022/053927

§ 371 Date: Jan. 8, 2025

(30) Foreign Application Priority Data
Aug. 14, 2022 (IN) 202221046299

(51) Int. Cl. G09G 3/00; H04N 23/667

(52) U.S. Cl. CPC G09G 3/001; H04N 23/667; G09G 2320/0626; G09G 2330/045; G09G 2354/00

(57) ABSTRACT

In one aspect, a wearable device a set of one or more temperature sensors configured to generate a first set of one or more temperature signals indicative of one or more skin temperatures of a user; a thermal controller configured to generate a signal indicative of a thermal mitigation level based on the set of one or more temperature signals; a set of one or more subsystems configured to perform one or more operations based on the thermal mitigation level signal, respectively; and a communication interface configured to send the thermal mitigation level signal to a companion device. In another aspect, a companion device configured to assist the wearable device in thermal management by offloading processes from the wearable device, and providing reduced data to the wearable device.

### FIELD

Aspects of the present disclosure relate generally to wearable devices (e.g., smart glasses, augmented reality (AR) viewers, virtual reality (VR) viewers, wearable fitness devices, wearable health monitoring, smart watches, etc.), and in particular, to thermal management in wearable devices including assistance from companion devices.

### BACKGROUND

Wearable devices, smart glasses, augmented reality (AR) viewers or glasses, virtual reality (VR) viewers or glasses, fitness measurement and tracking devices, health monitoring devices, medical treatment administering devices, smart watches, and others, are becoming more sophisticated, providing a multitude of functions. As such, wearable devices are designed with more powerful processors, integrated circuits (IC), system on chips (SOC), and other circuitry, that are capable of implementing the multitude of functions at generally high speeds. As a result, wearable devices are producing more heat. As these wearable devices are directly or indirectly in contact with users, the heat generated by such devices may become uncomfortable and/or harmful to users. Thus, there may be a need to implement thermal management for such wearable devices.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to a wearable device. The wearable device includes a first set of one or more temperature sensors configured to generate a first set of one or more temperature signals indicative of one or more skin temperatures of a user; a thermal controller configured to generate a signal indicative of a thermal mitigation level based on the first set of one or more temperature signals; a set of one or more subsystems configured to perform one or more operations based on the thermal mitigation level signal, respectively; and a communication interface configured to send the thermal mitigation level signal to a companion device.

Another aspect of the disclosure relates to a method of applying thermal management at a wearable device, including generating a first set of one or more temperature signals indicative of one or more temperatures; generating a signal indicative of a thermal mitigation level based on the first set of one or more temperature signals; performing one or more operations based on the thermal mitigation level signal; and sending the thermal mitigation level signal to a companion device.

Another aspect of the disclosure relates to a companion device for a wearable device, including: a communication interface configured to receive at least one of a thermal mitigation level signal or one or more thermal mitigation scheme parameters and a first set of data from the wearable device; a thermal controller configured to generate a thermal mitigation scheme for a benefit of the wearable device based on the at least one of the thermal mitigation level signal or the one or more thermal mitigation scheme parameters; and a first set of one or more subsystems configured to generate a second set of data based on the first set of data and the thermal mitigation scheme, wherein the second set of data is sent to the wearable device via the communication interface.

Another aspect of the disclosure relates to a method providing thermal management for a benefit of a wearable device, including: receiving at least one of a thermal mitigation level signal or one or more thermal mitigation scheme parameters and a first set of data from the wearable device; generating a thermal mitigation scheme for the benefit of the wearable device based on the at least one of the thermal mitigation level signal or the one or more thermal mitigation scheme parameters; generating a second set of data based on the first set of data and the thermal mitigation scheme; and sending the second set of data to the wearable device.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example system including an example wearable device tethered to an example companion device in accordance with an aspect of the disclosure.

FIGS. 2-1 and 2-2 illustrate a flow diagram of an example method of performing thermal management in the wearable device of FIG. 1 in accordance with another aspect of the disclosure.

FIGS. 3-1 and 3-2 illustrate a flow diagram of an example method of performing thermal management by the companion device of FIG. 1 for the benefit of the wearable device of FIG. 1 in accordance with another aspect of the disclosure.

FIG. 4 illustrates a perspective view of example augmented reality (AR) glasses in accordance with another aspect of the disclosure.

FIG. 5A illustrates a block diagram of example augmented reality (AR) glasses in accordance with another aspect of the disclosure.

FIG. 5B illustrates a table of example thermal mitigation schemes applied in the augmented reality (AR) glasses of FIG. 5A in accordance with another aspect of the disclosure.

FIG. 6A illustrates a block diagram of an example companion device to the augmented reality (AR) glasses of FIG. 5A in accordance with another aspect of the disclosure.

FIG. 6B illustrates a table of example thermal mitigation schemes applied by the companion device of FIG. 6A for the benefit of the augmented reality (AR) glasses of FIG. 5A in accordance with another aspect of the disclosure.

FIG. 7 illustrates a flow diagram of an example method of performing thermal mitigation for the benefit of a wearable device by the wearable and companion devices in accordance with another aspect of the disclosure.

FIG. 8 illustrates a block diagram of another example wearable device in accordance with another aspect of the disclosure.

FIG. 9 illustrates a block diagram of another example companion device to a wearable device in accordance with another aspect of the disclosure.

FIG. 10 illustrates a block diagram of another example wearable device in accordance with another aspect of the disclosure.

FIG. 11 illustrates a flow diagram of an example method of applying thermal management at a wearable device in accordance with another aspect of the disclosure.

FIG. 12 illustrates a block diagram of another example companion device to a wearable device in accordance with another aspect of the disclosure.

FIG. 13 illustrates a flow diagram of an example method of providing thermal management for a benefit of a wearable device in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Wearable devices have become very popular and ubiquitous. Such wearable devices include smart glasses, augmented reality (AR) viewers or glasses, virtual reality (VR) viewers or glasses, fitness measurement and tracking devices, health monitoring devices, medical treatment administering devices, smart watches, and others. These wearable devices are continually being designed to provide more functionality, to operate at greater speeds, and to operate for longer periods (e.g., continuously based on battery capability).

As a result of these enhancements, wearable devices are generating more heat. As these devices are worn by users, and are in contact or in proximity with the user's skin, the increase heat may make it uncomfortable and/or unsafe to users. For example, heat from such wearable devices that results in skin temperature of about 40 to 45 degrees Celsius (C) may be unacceptable, and thresholds for thermal management may be set within such range or in proximity thereof. Moreover, wearable devices usually have integrated circuits (ICs), such as system on chips (SOCs), that may be adversely affected (e.g., in terms of operations and/or physical damage) by the heat generated by such devices. Accordingly, monitoring of temperatures, such as junction temperatures, within such ICs to maintain them below safe operating limits (e.g., 70 to 95° C.) is also of interest to improve the reliability of such wearable devices.

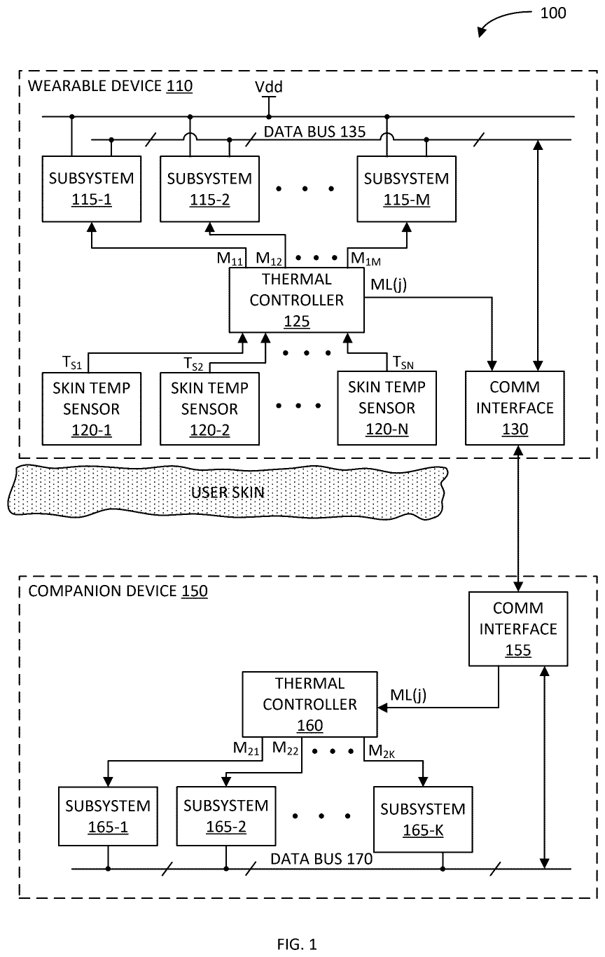

FIG. 1 illustrates a block diagram of an example system 100 including an example wearable device 110 (may also be referred to as a “primary device”) and an example companion device 150 (may also be referred to as a “secondary device”) in accordance with an aspect of the disclosure. As previously discussed, the wearable device 110 may take on various form factors, such as smart glasses, AR viewers or glasses, VR viewers or glasses, fitness measurement and tracking devices, health monitoring devices, medical treatment administering devices, smart watches, and others. The companion device 150 may also take on various form factors, such as smart phones, pucks, personal computers (e.g., desktop, laptop, tablet device, etc.), servers, and others. The companion device 150 and the wearable device 110 may be part of a personal area network (PAN). The companion device 140 may be a portable device. In some aspects, the companion device 150 may be carried by a user without being (continuously) worn.

The companion device 150 is tethered, e.g., wirelessly tethered, to and works with the wearable device 110 in performing a particular application. For example, as in the case of an AR viewer or glasses, the wearable device 110 may perform object detection, object pose processing (e.g., six degree of freedom (6 DOF) object-pose processing, where the object's x-, y-, z-positional coordinates, and the pitch, yaw, and roll orientation are determined), eye tracking, head tracking, hand tracking, and provide such information to the companion device 150. The companion device 150, in turn, may generate AR content based on the object pose and tracking information received, display rendering to include such AR content, encode the rendered display information, and send the information back to the AR glasses. The AR glasses then process the rendered display information for displaying the AR content along with the scene being captured by cameras of the AR glasses.

In particular, the wearable device 110 includes a set of one or more subsystems 115-1, 115-2, to 115-M, where M is any positive integer. As an example, in the case of an AR viewer, the subsystem 115-1 may be one or more 6 DOF cameras, the subsystem 115-2 may be a video camera, the subsystem 115-3 may be one or more displays (e.g., a display for each eye), the subsystem 115-4 may be an engine for visual analytics (EVA), which may be implemented as a hardware accelerator for object detection and late-stage reprojection (LSR) processing, the subsystem 115-5 may be a digital signal processor (DSP) (also referred to as a data processing unit (DPU)) for performing object pose (6DOF) processing, the subsystem 115-6 may be eye tracking cameras, and the subsystem 115-7 may be an infrared (IR) illumination system. It shall be understood that the aforementioned are merely examples of subsystems, and may vary substantially based on the particular AR glasses or other wearable devices. The subsystems may be characterized in that they require power and generate heat when in operation.

The wearable device 110 further includes a power (supply voltage) rail Vdd coupled to the set of one or more subsystems 115-1 to 115-M. Although one power rail Vdd is shown for explanation purposes, it shall be understood that the wearable device 110 may include a set of power rails, wherein the subsystems 115-1 to 115-M may be coupled to different combinations of such power rails. For example, in the case where the wearable device 110 is an AR viewer, there may be a multimedia power rail for supplying power to 6DOF cameras, video camera, eye tracking cameras, and EVA hardware accelerator; a compute power rail for supplying power to a DSP; and an IR illumination power rail for supplying power to an IR illumination system. The wearable device 110 further includes a data bus 135 for data coupling one or more of the subsystems 115-1 to 115-M and other components.

For thermal management, the wearable device 110 includes a set of one or more skin temperature sensors 120-1, 120-2 to 120-N, where N is any positive integer. The set of one or more skin temperature sensors 120-1 to 120-N may be placed in contact with or in proximity to various location(s) of a user's skin (as depicted) when the wearable device 110 is worn by a user. The set of one or more skin temperature sensors 120-1, 120-2 to 120-N may be configured to generate a set of one or more temperature signals T_{S1}, T_{S2} to T_{SN} indicative of one or more temperatures proximate one or more skin locations of a user, respectively.

Further, the wearable device 110 includes a thermal controller 125 for providing thermal management of the wearable device 110. The thermal controller 125 is configured to: receive the set of one or more temperature signals T_{S1} to T_{SN} from the set of one or more skin temperature sensors 120-1 to 120-N, respectively; compare the temperature signals T_{S1} to T_{SN} to one or more temperature thresholds; generate a thermal mitigation level signal ML(j) based on the temperature-threshold comparison; generate a set of one or more thermal mitigation scheme signals M₁₁ to M_{1M} to control the operations of the set of one or more subsystems 115-1 to 115-M, respectively; and send the thermal mitigation level signal ML(j) to the companion device 150 via a (wired or wireless) communication interface 130 (e.g., a Bluetooth, WiFi, USB, cellular, or other).

In response to the set of one or more thermal mitigation scheme signals M₁₁ to M_{1M}, the set of one or more subsystems 115-1 to 115-M may adjust their respective operations to reduce power consumption so that the wearable device 110 produces less heat, and the set of one or more temperature signals T_{S1} to T_{SN} subsequently indicate temperatures below the thresholds. For example, in the case where the wearable device 110 is an AR viewer, the 6DOF camera subsystem 115-1 may reduce a frames per second (FPS) rate associated with image capturing by one or more 6DOF cameras, may reduce a resolution associated with image capturing by one or more 6DOF cameras, and/or may reduce a number of enabled 6DOF cameras (e.g., disable one or more of head, eye (e.g., eye tracking subsystem 115-6 if separate from 6DOF camera subsystem 115-1), hand, mouth, eyebrow, and/or face tracking cameras) based on the thermal mitigation scheme signal M₁₁. The video camera subsystem 115-2 may reduce its video capturing FPS rate, its resolution, and/or may disable video capturing altogether based on the thermal mitigation level scheme signal M₁₂.

The display subsystem 115-3 may reduce its FPS rate, its resolution, disable one or more of the displays (e.g., the left-eye display, the right-eye display, or both) optionally based on eye position as detected by the eye tracking subsystem, and/or reduce the display brightness based on the thermal mitigation scheme signal M₁₃. The DSP subsystem 115-5 may offload part or all of its object pose (6DOF) processing to the companion device 150 based on the thermal mitigation scheme signal M₁₅. As an extension of the offloading feature, the DSP subsystem 115-1 may perform hopping of the processing between the DSP subsystem 115-1 and the companion device 150 based on the thermal mitigation scheme signal M₁₅. Hopping means jumping between a configuration where an algorithm is performed in the wearable device (e.g., when the mitigation level is relatively low) and a configuration where the algorithm is offloaded to the companion device (e.g., when the mitigation level is relatively high). For example, the hopping of the processing may be based on a degree of movement of a user's head and eyes. For instance, if such movements are below thresholds, then it may be better to offload more of the processing to the companion device 150 as the delay associated with offloading may not affect data processing associated with the relatively small movement; otherwise, the delay associated with offloading may affect data processing associated with relatively large movements. The IR illumination subsystem 115-7 may disable one or more light emitting diodes (LEDs), reduce its brightness, and/or disable one or more IR illumination sources based on the thermal mitigation scheme signal M₁₇. It shall be understood that the aforementioned thermal mitigations schemes are merely examples, and different sets of thermal mitigations schemes may be employed.

The companion device 150 includes a communication interface 155 (e.g., a Bluetooth, WiFi, USB, cellular, or other), a thermal controller 160, a set of one or more subsystems 165-1 to 165-K, and a data bus 170. The set of one or more subsystems may include one or more subsystems which share or supplement a function or functionality with/of one or more subsystems of the wearable device 110. For example, in the case where the companion device 150 is assisting in an application provided by the AR viewer wearable device 110, the subsystem 165-1 may be a DSP (or DPU) to perform part or all of the object pose (6DOF) processing based on object-related data received from the AR viewer wearable device 110, the subsystem 165-2 may be a processor for adding AR content based on the object-related data received from the AR viewer wearable device 110, and the subsystem 165-3 may be a display rendering and encoding system for generating graphics or image rendering data (frame-pixel) information of the AR content to send to the AR viewer wearable device 110 for processing and displaying purposes.

With regard to providing thermal management on behalf of the wearable device 110, the thermal controller 160 receives the thermal mitigation level signal ML(j) from the wearable device 110 via the communication interface 155. The thermal controller 160 generates a set of one or more thermal mitigation scheme signals M₂₁ to M_{2K} to control the operations of the set of one or more subsystems 165-1 to 165-K, respectively. Considering again the AR application example, the DSP subsystem 165-1 may offload some or all of the object-pose (6DOF) processing from the wearable device 110 based on the thermal mitigation scheme signal M₂₁. The AR content generating subsystem 165-2 may reduce the number of AR contents in the object image signal received from the wearable device 110 based on the thermal mitigation scheme signal M₂₂. And, the display rendering subsystem 165-3 may reduce the resolution and FPS rate associated with the image signal or data to be provided to the wearable device 110.

The offloading of some or all of the object-pose (6DOF) processing from the wearable device 110, the reduction of the AR content in the image signal, and/or the reduced resolution and FPS of the image rendering signal or data provided to the wearable device 110 result in less processing (workload), and therefore, less power consumption in the wearable device 110; and as a consequence, less heat produced by the wearable device 110 to reduce and maintain the skin temperatures as indicated by the temperature signals T_{S1} to T_{SN} below corresponding thresholds. More specifically, with regard to fewer AR content and reduced resolutions and FPS in the image signal or data provided to the wearable device 110, the EVA hardware accelerator subsystem 115-4 for late-stage reprojection (LSR) (which is for correcting the rendered data to match the latest pose data in the AR viewer wearable device 110) has less data to process; thereby, reducing its power consumption and heat production.

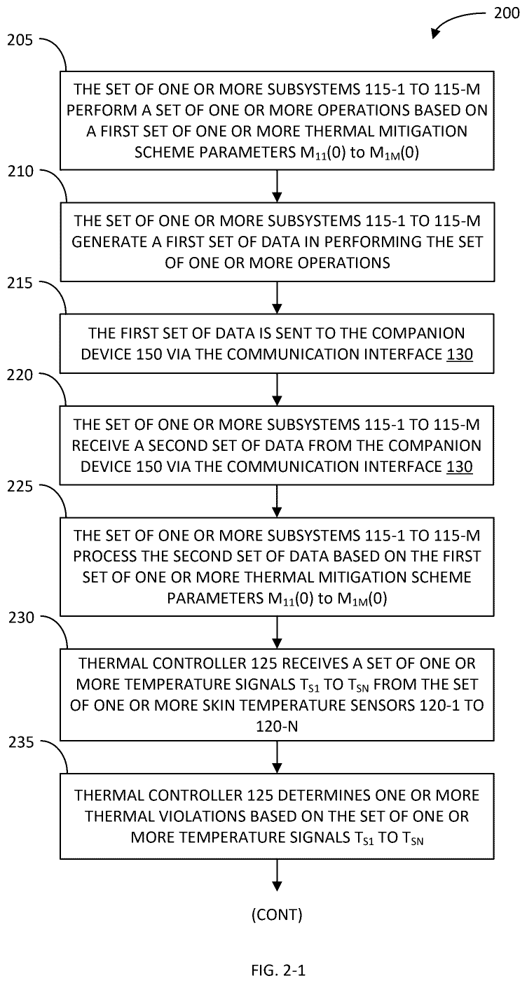

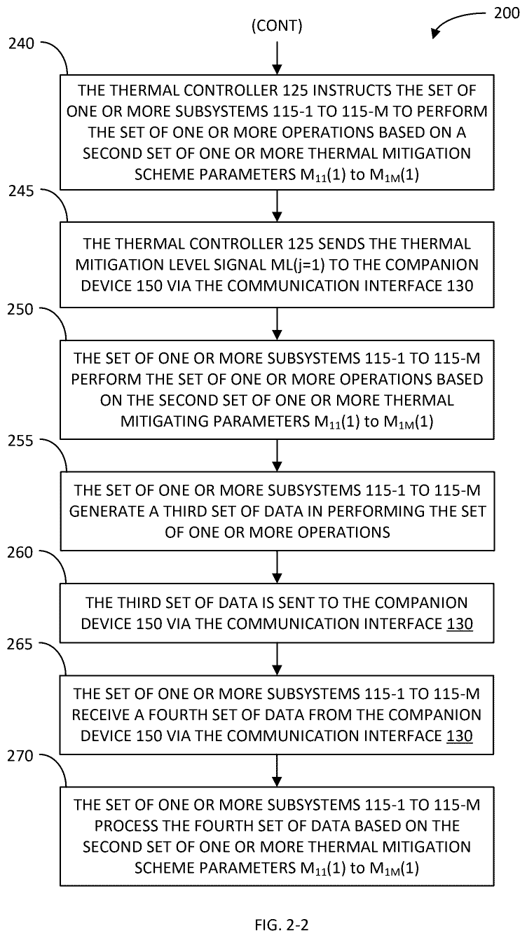

FIGS. 2-1 and 2-2 illustrate a flow diagram of an example method 200 of performing thermal management in the wearable device 110 in accordance with another aspect of the disclosure.

The method 200 includes the set of one or more subsystems 115-1 to 115-M performing a set of one or more operations based on a first set of one or more thermal mitigation scheme parameters M₁₁(0) to M_{1M}(0) (block 205). As an example, the first set of one or more thermal mitigation scheme parameters M₁₁(0) to M_{1M}(0) may pertain to an unmitigated thermal operation (e.g., where “0” indicates the unmitigated level) where the set of one or more skin temperature signals T_{S1} to T_{SN} indicate skin temperatures below all thresholds. Thermal mitigation scheme parameters may include any parameters which control the operation of the respective one or more subsystems. In some aspects, thermal mitigation scheme parameters may include control parameters for operating the one or more subsystems which affect the heat production of the respective subsystems, e.g., by having an impact on the current power consumption of the respective subsystems. The first set of one or more thermal mitigation scheme parameters may be associated with a normal or standard operation of the respective subsystems, e.g., with operating the respective subsystems at nominal power levels.

Considering again the example AR viewer wearable device 110, the thermal mitigation scheme parameter M₁₁(0) may indicate a particular FPS (e.g., 81 FPS) for the 6DOF camera subsystem 115-1; the thermal mitigation scheme parameter M₁₂(0) may indicate a particular resolution (e.g., 1600×1200 pixels²) for the video camera subsystem 115-2; the thermal mitigation scheme parameter M₁₃(0) may indicate a particular resolution (e.g., 1280×960 pixels²) for the display subsystem 115-3; the thermal mitigation scheme parameter M₁₅(0) may indicate that the DSP subsystem 115-5 performs 80 percent (%) of the 6 DOF processing (while the companion device 150 performs 20% of the 6 DOF processing); and the thermal mitigation scheme parameter M₁₇(0) may indicate an 80% output illumination power of the IR illumination subsystem 115-7. In performing the aforementioned operations, the power consumption of the wearable device 110 may be represented as P₀₁.

The method 200 further includes the set of one or more subsystems 115-1 to 115-M generating a first set of data in performing the set of one or more operations (block 210). Considering the example AR viewer wearable device 110, the 6 DOF camera subsystem 115-1, the EVA subsystem 115-4, and DSP subsystem 115-5 may collectively generate object-pose (6 DOF) data (the first set of data) of objects of a scene captured by the 6 DOF camera subsystem 115-1. Further, the method 200 includes the first set of data being sent to the companion device 150 via the communication interface 130 (block 215). As depicted in FIG. 1, the communication interface 130 may be coupled to the data bus 135 to receive the first set of data, and transmit the first set of data to the companion device 150 in accordance with any transmission protocols (e.g., Bluetooth, WiFi, USB, cellular, etc.).

Then, according to the method 200, the set of one or more subsystems 115-1 to 115-M receives a second set of data from the companion device 150 via the communication interface 130 (block 220). The second set of data may be based on the first set of data. For example, in the case of the AR viewer wearable device 110, the second set of data may include AR content associated with the object-pose data (first set of data) of the one or more detected objects (e.g., the object-pose data may be a detected face and the AR content may be graphical glasses for the detected face). In some aspects, offloading operations to the companion device comprises generating data at the companion device which could alternatively be generated at the wearable device itself. For instance, the second set of data could be generated at the wearable device itself based on the first set of data. By offloading the corresponding operation or operations, the processing load and heat generation of the corresponding one or more subsystems of the wearable device are reduced.

Additionally, the method 200 includes the set of one or more subsystems 115-1 to 115-M processing the second set of data based on the first set of one or more thermal mitigating scheme parameters M₁₁(0) to M_{1M}(0) (block 225). For example, in the AR viewer wearable device 110, the EVA subsystem 115-4 may receive the second set of data via the data bus 135, and perform late-stage reprojection (LSR) processing to correct the rendered second set of data to match the latest pose data (as there is some time delay between the captured pose and the time the second set of data is to be rendered by the display subsystem 115-3). The display subsystem 115-3 then displays the LSR corrected second set of data for viewing by the user. The thermal mitigation scheme parameter M₁₃(0) may specify a particular resolution and FPS (e.g., 1280×960 pixels², 480 Hz per eye) for displaying the LSR corrected second set of data. In processing and displaying the second set of data, the power consumption of the wearable device 110 may be represented as P₀₂. Thus, in accordance with the thermal unmitigated level, the wearable device 110 may consume a total power P₀ equal to the sum of P₀₁ and P₀₂ (e.g., P₀=P₀₁+P₀₂).

The method 200 further includes the thermal controller 125 receiving the set of one or more temperature signals T_{S1} to T_{SN} from the set of one or more skin temperature sensors 120-1 to 120-N, respectively (block 230). Although this operation is being shown as the sixth operation of the method 200, it shall be understood that the thermal controller 125 may receive the set of one or more temperature signals T_{S1} to T_{SN} continuously (e.g., at a certain periodic signal/data rate). Then, according to the method 200, the thermal controller 125 determines one or more thermal violations (e.g., temperature above a respective threshold) based on the set of one or more temperature signals T_{S1} to T_{SN} (block 235). For example, the temperature signal T_{S1} may indicate a skin temperature above a temperature threshold of 40° C.

Further, the method 200 includes the thermal controller 125 instructing the set of one or more subsystems 115-1 to 115-M to perform the set of one or more operations based on a second set of one or more thermal mitigation scheme parameters M₁₁(1) to M_{1M}(1) (block 240). Considering again the example AR viewer wearable device 110, the thermal mitigation scheme parameter M₁₁(1) may indicate a particular FPS (e.g., 55 FPS) for the 6 DOF camera subsystem 115-1; the thermal mitigation scheme parameter M₁₂(1) may indicate a particular resolution (e.g., 800×600 pixels²) for the video camera subsystem 115-2; the thermal mitigation scheme parameter M₁₃(1) may indicate a particular resolution (e.g., 640×480 pixels²) for the display subsystem 115-3; the thermal mitigation scheme parameter M₁₅(1) may indicate that the DSP subsystem 115-5 performs 40 percent (%) of the 6 DOF processing (while the companion device 150 performs 60% of the 6 DOF processing); and the thermal mitigation scheme parameter M₁₇(1) may indicate a 60% output illumination power of the IR illumination subsystem 115-7. In general, the second set of one or more thermal mitigation scheme parameters may be associated with a reduced or limited operation (as compared to the normal or standard operation) of the respective subsystems, e.g., with operating the respective subsystems at lower than nominal power levels.

Further, according to the method 200, the thermal controller 125 sends the thermal mitigation level signal ML(j=1) to the companion device 150 via the communication interface 130 (block 245). As discussed further herein, the companion device 150 also throttles its operations and/or offloads processing from the wearable device 110 in response to the thermal mitigation level signal ML(j=1) indicating a higher thermal mitigation level.

Additionally, the method 200 includes the set of one or more subsystems 115-1 to 115-M performing the set of one or more operations based on the second set of one or more thermal mitigation scheme parameters M₁₁(1) to M_{1M}(1) (block 250). In performing the aforementioned operations, the power consumption of the wearable device 110 may be represented as P₁₁. Note that the operations of the set of one or more subsystems 115-1 to 115-M are throttled (reduced) based on the second set of one or more thermal mitigation scheme parameters M₁₁(1) to M_{1M}(1). Accordingly, the power consumption P₁₁ of the wearable device 110 in accordance with mitigation level “1” is less than the power consumption P₀₁ in accordance with the unmitigated level “0”. As a result, the wearable device 110 is producing less heat so as to bring the skin temperature or the temperature near the skin below the threshold (e.g., 40° C.), which may be more comfortable for the user.

The method 200 also includes the set of one or more subsystems 115-1 to 115-M generating a third set of data in performing the set of one or more operations as indicated in block 250 (block 255). For example, in the AR viewer wearable device 110, the 6 DOF camera subsystem 115-1, the EVA subsystem 115-4, and DSP subsystem 115-5 may collectively generate object-pose (6 DOF) data (the third set of data) of the objects of the scene captured by the 6 DOF camera subsystem 115-1. Further, the method 200 includes the third set of data being sent to the companion device 150 via the communication interface 130 (block 260).

Then, according to the method 200, the set of one or more subsystems 115-1 to 115-M receives a fourth set of data from the companion device 150 via the communication interface 130 (block 265). The fourth set of data may be based on the third set of data. For example, in the case of the AR viewer wearable device 110, the fourth set of data may include AR content associated with the object-pose data (the third set of data) of the one or more detected objects. As the companion device 150 has throttled its operations in response to receiving the thermal mitigation level signal ML(j=1) in block 245, the fourth set of data is reduced compared to the second set of data received from the companion device 150 in the thermal unmitigated state per block 220.

Additionally, the method 200 includes the set of one or more subsystems 115-1 to 115-M processing the fourth set of data based on the second set of one or more thermal mitigation scheme parameters M₁₁(1) to M_{1M}(1) (block 270). As previously discussed, in the AR viewer wearable device 110, the EVA subsystem 115-4 may receive the fourth set of data via the data bus 135, and perform late-stage reprojection (LSR) processing to correct the rendered fourth set of data to match the latest pose data. The display subsystem 115-3 then displays the LSR corrected fourth set of data for viewing by the user. The thermal mitigation scheme parameter M₁₃(1) may specify a particular resolution and FPS (e.g., 640×480 pixels², 240 Hz per eye) for displaying the LSR corrected second set of data.

In processing and displaying the fourth set of data, the power consumption of the wearable device 110 may be represented as P₁₂. As the fourth set of data is reduced due to throttling by the companion device 150, the power P₁₂ is less than the power P₀₂ associated with processing and displaying the second set of data per block 225. Thus, in mitigation level “1”, the wearable device 110 consumes a total power P₁ equal to the sum of P₁₁ and P₁₂ (e.g., P₁=P₁₁+P₁₂), which is less than the total power P₀ consumed in the thermal unmitigated level “0”. This should bring down the skin temperature so that it is below the threshold for user comfort and safety.

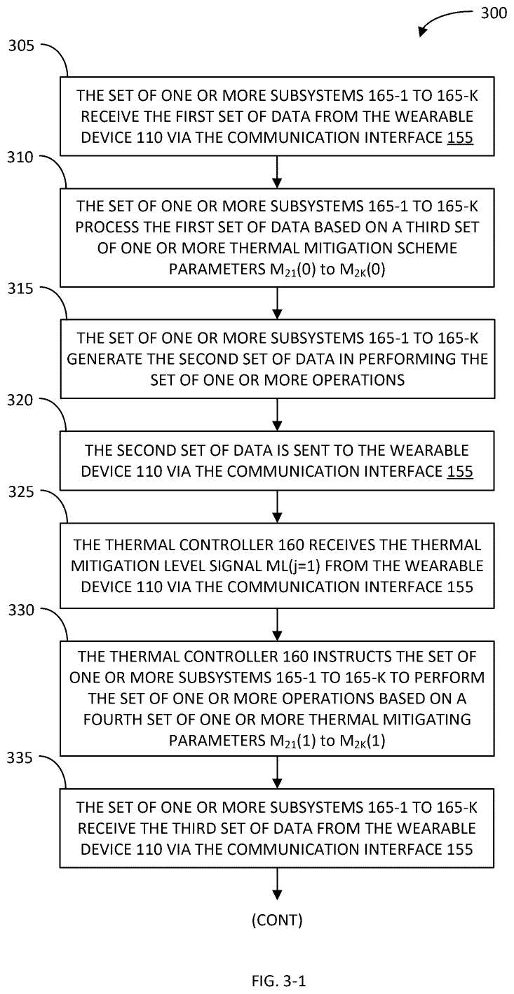

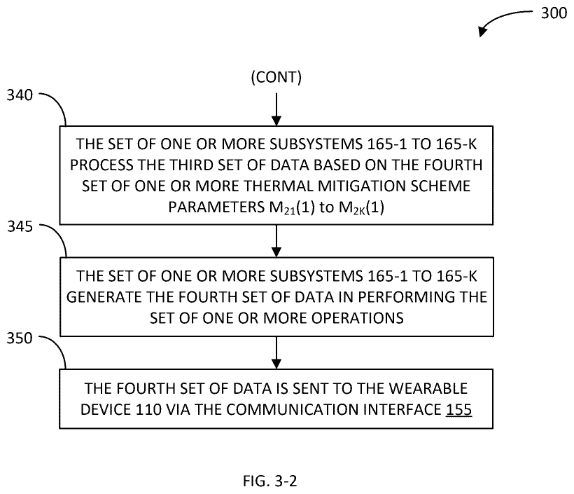

FIGS. 3-1 and 3-2 illustrate a flow diagram of an example method 300 of performing thermal management by the companion device 150 for the benefit of the wearable device 110 in accordance with another aspect of the disclosure.

The method 300 includes the set of one or more subsystems 165-1 to 165-K receiving the first set of data from the wearable device 110 via the communication interface 155 (block 305). As previously discussed with regard to the AR viewer wearable device 110, the first set of data may include object-pose data from one or more objects detected by the wearable device 110. The method 300 further includes the set of one or more subsystems 165-1 to 165-K processing the first set of data based on a third set of thermal mitigation scheme parameters M₂₁(0) to M_{2K}(0) (block 310). With regard to the AR viewer example, the DSP subsystem 165-1 may perform some object-pose (6 DOF) processing of the first set of data based on the thermal mitigation scheme parameter M₂₁(0); the AR content subsystem 165-2 may add AR content based on the first set of data based on the thermal mitigation scheme parameter M₂₂(0); and the display rendering subsystem 165-3 may render and encode an image signal or data containing the AR content for transmission back to the wearable device 110 based on the thermal mitigation scheme parameter M₂₃(0).

The set of one or more subsystems 165-1 to 165-K generates the second set of data in performing the set of one or more operations per block 310 (block 315). As discussed with regard to the AR viewer example, the DSP subsystem 165-1 may perform some object-pose (6 DOF) processing of the first set of data; the AR content subsystem 165-2 may add AR content based on the first set of data; and the display rendering subsystem 165-3 may render and encode an image signal (the second set of data) containing the AR content for transmission back to the wearable device 110 based on the thermal mitigation scheme parameters M₂₁(0) to M₂₃(0), respectively. Further, the method 300 includes the second set of data being sent to the wearable device 110 via the communication interface 155 (block 320). As depicted in FIG. 1, the communication interface 155 may be coupled to the data bus 170 to receive the second set of data, and transmit the second set of data to the wearable device 110 in accordance with any transmission protocols (e.g., Bluetooth, WiFi, USB, cellular, etc.).

The method 300 additionally includes the thermal controller 160 receiving the thermal mitigation level signal ML(j=1) from the wearable device 110 via the communication interface 155 (block 325). As indicated by the level “j” of the thermal mitigation level signal ML(j) being one (1), the companion device 150 is apprised of a thermal issue in the wearable device 110. In response to the thermal mitigation level signal ML(j=1), the thermal controller 160 instructs the set of one or more subsystems 165-1 to 165-K to perform the set of one or more operations based on a fourth set of one or more thermal mitigation scheme parameters M₂₁(1) to M_{2K}(1) (block 330). Considering the AR viewer example, the thermal mitigation scheme parameter M₂₁(1) may specify that the DSP subsystem 165-1 offloads more object-pose (6 DOF) processing from the wearable device 110; the thermal mitigation scheme parameter M₂₂(1) may specify that the AR content subsystem 165-2 adds less AR content (e.g., by ignoring one or more detected objects) to the image signal or data to be sent to the wearable device 110; and the thermal mitigation scheme parameter M₂₃(1) may specify that the display rendering subsystem 165-3 reduces the resolution and/or the FPS associated with the image signal or data to be sent to the wearable device 110.

Additionally, the method 300 includes the set of one or more subsystems 165-1 to 165-K receiving the third set of data from the wearable device 110 via the communication interface 155 (block 335). With regard to the AR viewer example, the third set of data may include object-pose data from one or more objects detected by the wearable device 110 at a later time (e.g., after the thermal mitigation level changed from j=0 to j=1). The method 300 further includes the set of one or more subsystems 165-1 to 165-K processing the third set of data based on the fourth set of one or more thermal mitigation scheme parameters M₂₁(1) to M_{2K}(1) (block 340). As previously discussed, this may entail the DSP subsystem 165-1 performing more object-pose (6 DOF) processing to offload some of that processing from the wearable device 110; the AR content subsystem 165-2 adding (albeit less) AR content (e.g., by ignoring one or more detected objects) to the image signal to be sent to the wearable device 110; and the display rendering subsystem 165-3 rendering the image signal or data including the AR content with reduced resolution and/or the FPS.

Further, the method 300 includes the set of one or more subsystems 165-1 to 165-K generating the fourth set of data in performing the set of one or more operations per block 340 (block 345). Finally, the method 300 includes the fourth set of data being sent to the wearable device 110 via the communication interface 155 (block 350). As previously discussed, the amount of data in the fourth set of data generated during thermal mitigation level ML(1) may be less than the amount of data in the second set of data generated during the thermal mitigation level ML(0). As a result, the wearable device 110 consumes less power in processing the fourth set of data, which helps in reducing the heat produced by the wearable device 110 so that the skin temperatures or the temperatures near the skin decrease below the thresholds.

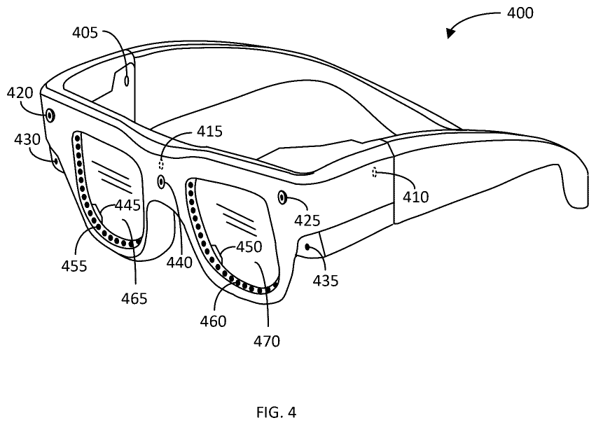

FIG. 4 illustrates a perspective view of example augmented reality (AR) glasses 400 in accordance with another aspect of the disclosure. As previously discussed, the AR glasses 400 are an example of a wearable device 110. Further, as previously mentioned, it shall be understood that a wearable device described herein may take on many different forms, such as fitness measurement and tracking devices, health monitoring devices, medical treatment administering devices, smart watches, earpieces, and others.

The AR glasses 400 include a set of skin temperature sensors 405, 410, and 415. The skin temperature sensor 405 may be positioned on the right temple side of the AR glasses 400. The skin temperature sensor 410 may be positioned on the left temple side of the AR glasses 400. The skin temperature sensor 415 may be positioned on the interior nose bridge of the AR glasses 400.

The AR glasses 400 further include right and left 6 DOF cameras 420 and 425 pointing generally forward, and situated on the exterior right and left rims near the right and left hinges of the AR glasses 400, respectively. The AR glasses 400 also include right and left infrared (IR) LEDs 430 and 435 also pointing generally forward, and situated on the exterior right and left rims below the right and left 6 DOF cameras 420 and 425, respectively. Further, the AR glasses 400 include a video (e.g., red, green, blue (RGB)) camera 440 pointing generally forward, and situated on the exterior nose bridge of the AR glasses 400.

For eye tracking, the AR glasses 400 include right and left eye tracking cameras 445 and 450 pointing in the directions of the right and left eyes of a user when the AR glasses are worn, and situated on the bridge interior sides of the right and left rims, respectively. Further, the AR glasses 400 include right and left infrared (IR) LED rings (e.g., series-or parallel-connected LEDs) 455 and 460 for illuminating the right and left eye regions of a user when the AR glasses are worn, and situated along the interior surfaces of the right and left rims, respectively. The AR glasses 400 includes right and left display lenses 465 and 470. It shall be understood that the aforementioned components, placements, and orientations are merely examples, and such configuration of AR glasses may take on many different forms.

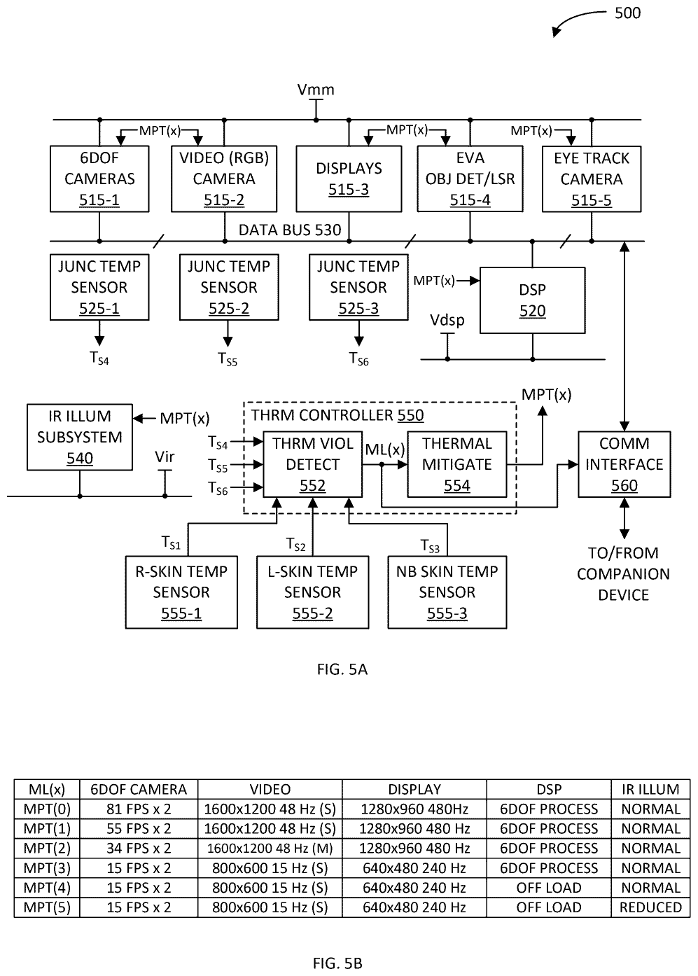

FIG. 5A illustrates a block diagram of example augmented reality (AR) glasses 500 in accordance with another aspect of the disclosure. The AR glasses 500 may be a hardware/functional example of the AR glasses 400 previously discussed. Additionally, the AR glasses 500 are based on the wearable device 110 previously discussed.

In particular, the AR glasses 500 include a 6 DOF camera subsystem 515-1, a video (RGB) camera subsystem 515-2, a display subsystem 515-3, an EVA (object detection and late-stage reprojection (LSR) processing) hardware accelerator subsystem 515-4, an eye tracking camera subsystem 515-5, and a DSP (or DPU) subsystem 520. The AR glasses 500 may further include a set of junction temperature sensors 525-1, 525-2, and 525-3 (e.g., three (3) in this example, but may could include more or less) situated at various locations (e.g., hot spots) within an SOC (e.g., near the DSP core 520, EVA core 515-4, etc.).

From a power rail perspective, the AR glasses 500 include a multimedia power (supply voltage) rail Vmm coupled to the 6 DOF camera subsystem 515-1, the video (RGB) camera subsystem 515-2, the display subsystem 515-3, the EVA (object detection and late-stage reprojection (LSR) processing) hardware accelerator subsystem 515-4, and the eye tracking camera subsystem 515-5. In this example, the AR glasses 500 include a separate power (supply voltage) rail Vdsp coupled to the DSP subsystem 520. From a data exchange perspective, the AR glasses 500 include a data bus 530 coupled to the 6 DOF camera subsystem 515-1, the video (RGB) camera subsystem 515-2, the display subsystem 515-3, the EVA (object detection and late-stage reprojection (LSR) processing) hardware accelerator subsystem 515-4, the eye tracking camera subsystem 515-5, and the DSP subsystem 520.

The AR glasses 500 further include an infrared (IR) illumination subsystem 540 coupled to its own power (supply voltage) rail Vir. Additionally, the AR glasses 500 include a communication interface 560 (e.g., Bluetooth, WiFi, USB, cellular, etc.) for communicating with a companion device as previously discussed. The communication interface 560 is coupled to the data bus 530 for receiving data therefrom, and providing data thereto.

Additionally, the AR glasses 500 include a thermal controller 550 including a thermal violation detector 552 and a thermal mitigator 554. Further, the AR glasses 500 include a set of skin temperature sensors 555-1 to 555-3 (e.g., three (3) in this example, but may could include more or less). For example, the temperature sensor 555-1 may be positioned on the right temple side of the AR glasses 500, the temperature sensor 555-2 may be positioned on the left temple side of the AR glasses 500, and the temperature sensor 555-3 may be positioned on the nose bridge of the AR glasses 500, as previously discussed with reference to AR glasses 400.

The thermal violation detector 552 of the thermal controller 550 includes inputs coupled to the skin temperature sensors 555-1 to 555-3 and the junction temperature sensors 525-1 to 525-3 to receive a set of temperature signals T_{S1} to T_{S6} generated by such sensors, respectively. The thermal violation detector 552 is configured to generate a thermal mitigation level signal ML(x) based on the set of temperature signals T_{S1} to T_{S6} and a set of one or more temperature thresholds.

For example, as discussed further herein, if none of the temperature signals T_{S1} to T_{S6} exceed a temperature threshold, then the thermal violation detector 552 may set the thermal mitigation level signal to ML(0) indicating no thermal mitigation. If one or both of the skin (temple) temperature signals T_{S1} and T_{S2} exceed a first (e.g., lowest) temperature threshold TH₁ (e.g., 40° C.), the thermal violation detector 552 may set the thermal mitigation level signal to ML(1) indicating a first (aggressive) level of thermal mitigation. If the skin (nose bridge) temperature signal T_{S3} exceeds a second (e.g., second lowest) temperature threshold TH₂ (e.g., 45° C.), the thermal violation detector 552 may set the thermal mitigation level signal to ML(2) indicating a second (aggressive) level of thermal mitigation. If a certain one of the junction temperature signals (e.g., T_{S4}) exceeds a third (e.g., third lowest) temperature threshold TH₃ (e.g., 70° C.), the thermal violation detector 552 may set the thermal mitigation level signal to ML(3) indicating a third (aggressive) level of thermal mitigation. It shall be understood that the above thermal mitigation levels and corresponding temperature thresholds are merely examples, and may be set differently depending on the thermal management strategy. In some aspects, a higher thermal mitigation level may indicate a more aggressive level of thermal mitigation. For example, setting the thermal mitigation level signal to ML(3) may lead to more aggressive thermal mitigation than setting the thermal mitigation level signal to ML(2), wherein a more aggressive thermal mitigation may, for instance, involve offloading a larger fraction of the processing, throttling additional operations, and/or reducing certain operations even more.

The thermal violation detector 552 includes an output, at which the thermal mitigation level signal ML(x) is produced, coupled to an input of the thermal mitigator 554 and to the communication interface 560. The thermal mitigator 554 is configured to generate a wearable device (primary) thermal mitigation technique or scheme signal MPT(x) based on the thermal mitigation level signal ML(x). The thermal mitigator 554 includes an output, at which the primary thermal mitigation scheme signal MPT(x) is produced, coupled to the 6 DOF camera subsystem 515-1, the video (RGB) camera subsystem 515-2, the display subsystem 515-3, the EVA (object detection and late-stage reprojection (LSR) processing) hardware accelerator subsystem 515-4, the eye tracking camera subsystem 515-5, the DSP subsystem 520, and the IR illumination subsystem 540.

FIG. 5B illustrates a table of example primary thermal mitigation schemes MPT(x) applied in the augmented reality (AR) glasses 500 in accordance with another aspect of the disclosure. The table includes seven (7) rows and six (6) columns.

From left to right, the first column represents the thermal mitigation level ML(x) and the corresponding primary thermal mitigation schemes MPT(0) to MPT(5), e.g., comprising sets of thermal mitigation scheme parameters, wherein x may indicate a mitigation level index. The second column represents example primary thermal mitigation schemes MPT(0) to MPT(5) applied to the 6 DOF camera subsystem 515-1. The third column represents example primary thermal mitigation schemes MPT(0) to MPT(5) applied to the video (RGB) camera subsystem 515-2. The fourth column represents example primary thermal mitigation schemes MPT(0) to MPT(5) applied to the display subsystem 515-3. The fifth column represents example primary thermal mitigation schemes MPT(0) to MPT(5) applied to the DSP subsystem 520. The sixth column represents example primary thermal mitigation schemes MPT(0) to MPT(5) applied to the IR illumination subsystem 540.

For example, with regard to the unmitigated thermal level ML(0), the corresponding primary thermal unmitigated scheme MPT(0) includes: operating the 6 DOF camera subsystem 515-1 with an FPS of 81 for both right- and left-cameras (x2); operating the video (RGB) camera subsystem 515-2 with a resolution 1600×1200 pixels² at a frame rate of 48 Hertz (Hz) in stereo (S); operating the display subsystem 515-3 with a resolution of 1280×960 pixels² at a frame rate of 480 Hz; operating the DSP subsystem 520 to perform 6 DOF processing; and operating the IR illumination subsystem 540 in a normal manner (e.g., all IR LEDs enabled and illumination power at normal levels).

With regard to the thermal mitigation level ML(1), the corresponding primary thermal mitigation scheme MPT(1) includes: operating the 6 DOF camera subsystem 515-1 with an FPS of 55 for both right-and left-cameras (x2); operating the video (RGB) camera subsystem 515-2 with a resolution 1600×1200 pixels² at a frame rate of 48 Hz in stereo (S); operating the display subsystem 515-3 with a resolution of 1280×960 pixels² at a frame rate of 480 Hz; operating the DSP subsystem 520 to perform 6 DOF processing; and operating the IR illumination subsystem 540 in a normal manner (e.g., all IR LEDs enabled and illumination power at normal levels). Note that the first primary thermal mitigation scheme MPT(1) may be the least aggressive mitigation scheme where, in this example, the operation of the 6 DOF camera subsystem 515-1 is throttled (e.g., 55 FPS for MPT(1) compared to 81 FPS for MPT(0)).

With regard to the thermal mitigation level ML(2), the corresponding primary thermal mitigation scheme MPT(2) includes: operating the 6 DOF camera subsystem 515-1 with an FPS of 34 for both right-and left-cameras (x2); operating the video (RGB) camera subsystem 515-2 with a resolution 1600×1200 pixels² at a frame rate of 48 Hz in mono (M); operating the display subsystem 515-3 with a resolution of 1280×960 pixels² at a frame rate of 480 Hz; operating the DSP subsystem 520 to perform 6 DOF processing; and operating the IR illumination subsystem 540 in a normal manner (e.g., all IR LEDs enabled and illumination power at normal levels). Note that the second primary thermal mitigation scheme MPT(2) may be more aggressive than the first primary thermal mitigation scheme MPT(1) where, in this example, the operation of the 6 DOF camera subsystem 515-1 is further throttled (e.g., 34 FPS for MPT(2) compared to 55 FPS for MPT(1)); and additionally, the operation of the video (RGB) camera subsystem 515-2 is also throttled (e.g., mono video capturing for MPT(2) compared to stereo video capturing for MPT(1)).

Skipping to thermal mitigation level ML(4), the corresponding primary thermal mitigation scheme MPT(4) includes: operating the 6 DOF camera subsystem 515-1 with an FPS of 15 for both right-and left-cameras (x2); operating the video (RGB) camera subsystem 515-2 with a resolution 800×600 pixels² at a frame rate of 15 Hz in stereo (S); operating the display subsystem 515-3 with a resolution of 640×480 pixels² at a frame rate of 240 Hz; operating the DSP subsystem 520 to offload at least a portion of the 6 DOF processing (that is performed in the other mitigation levels MPT(0) to MPT(3)); and operating the IR illumination subsystem 540 in a normal manner (e.g., all IR LEDs enabled and illumination power at normal levels). Note that the fourth primary thermal mitigation scheme MPT(4) may be significantly more aggressive than the second primary thermal mitigation scheme MPT(2) where, in this example, the operation of the 6 DOF camera subsystem 515-1 is further throttled (e.g., 15 FPS for MPT(4) compared to 34 FPS for MPT(2)); the operation of the video (RGB) camera subsystem 515-2 is also throttled (e.g., 800×600 pixels² at a frame rate of 15 Hz in stereo (S) for MPT(4) compared to 1600×1200 pixels² at a frame rate of 48 Hz in mono (M) for MPT(2)); and the operation of the DSP subsystem 520 is throttled as it is offloading at least some 6 DOF processing to the companion device.

The other example primary thermal mitigation schemes MPT(3) and MPT(5) are explained in the Table. It shall be understood that these thermal mitigation schemes are merely examples, and the schemes employed may vary significantly based on the thermal management strategy employed.

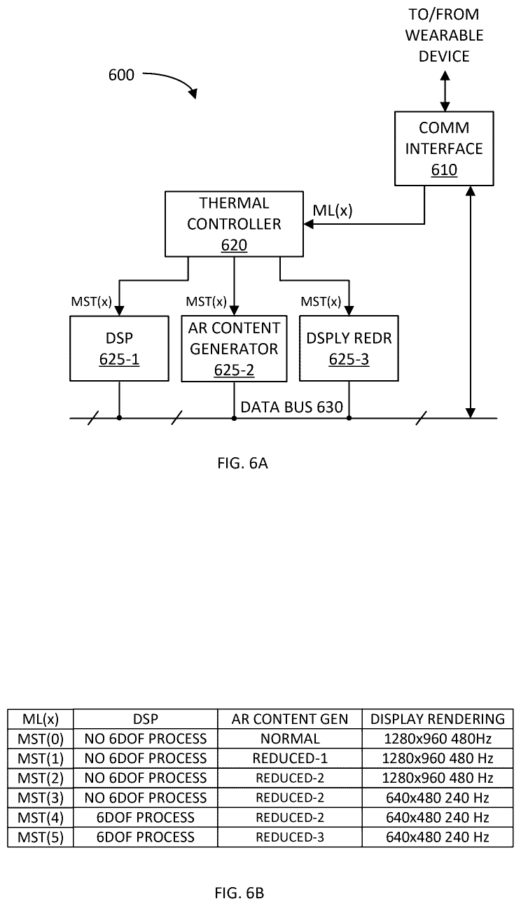

FIG. 6A illustrates a block diagram of an example companion device 600 to the example augmented reality (AR) glasses 500 in accordance with another aspect of the disclosure. The companion device 600 may be a hardware/functional example of a companion device used in performing AR applications in conjunction with the AR glasses 500 previously discussed. Additionally, the companion device 600 is based on the companion device 150 previously discussed.

In particular, the companion device 600 includes a communication interface 610 (e.g., Bluetooth, WiFi, USB, cellular, etc.) for communicating with the AR glasses 500, such as receiving object-related data and thermal mitigation level ML(x) information from the AR glasses 500, and providing display rendering data to the AR glasses 500. Additionally, the companion device 600 includes a thermal controller 620 coupled to the communication interface 610 to receive the thermal mitigation level ML(x) from the AR glasses 500. The thermal controller 620 is configured to generate a secondary thermal mitigation scheme MST(x) based on the thermal mitigation level ML(x).

Additionally, the companion device 600 includes a DSP (or DPU) subsystem 625-1, an AR content generator subsystem 625-2, and a display rendering subsystem 625-3. As previously discussed, the DSP subsystem 625-1 may receive object-pose (6 DOF) data from the AR glasses 500 via the communication interface 610 and a data bus 630, and may perform additional object pose (6 DOF) processing on the data. The AR content generator subsystem 625-2 may generate AR content based on the object-pose (6 DOF) data received from the AR glasses 500 and/or additionally processed by the DSP subsystem 625-1 via the data bus 630. The display rendering subsystem 625-3 may receive the AR content from the AR content generator 625-2 via the data bus 630, and generate an image signal or data including the AR content. The image signal is then sent to the AR glasses 500 via the data bus 630 and communication interface 610 for further processing and displaying.

With regard to thermal management, the thermal controller 620 is configured to control the operations of the DSP subsystem 625-1, AR content generator 625-2, and/or display rendering subsystem 625-3 based on the secondary thermal mitigation scheme MST(x) that corresponds to the thermal mitigation level ML(x) received from the AR glasses 500 via the communication interface 610.

FIG. 6B illustrates a table of example secondary thermal mitigation schemes applied by the companion device 600 for the benefit of the AR glasses 500 in accordance with another aspect of the disclosure. The table includes seven (7) rows and four (4) columns.

From left to right, the first column represents the thermal mitigation level ML(x) and the corresponding secondary thermal mitigation schemes MST(0) to MST(5), e.g., comprising sets of thermal mitigation scheme parameters, wherein x may indicate a mitigation level index. The second column represents example secondary thermal mitigation schemes MST(0) to MST(5) applied to the DSP subsystem 625-1. The third column represents example secondary thermal mitigation schemes MST(0) to MST(5) applied to the AR content generator subsystem 625-2. The fourth column represents example secondary thermal mitigation schemes MST(0) to MST(5) applied to the display rendering subsystem 625-3.

For example, with regard to the unmitigated thermal level ML(0), the corresponding secondary thermal unmitigated scheme MPT(0) includes: operating the DSP subsystem 625-1 such that it does no object-pose (6 DOF) processing or at a level consistent with no thermal issues associated with the AR glasses 500 (e.g., no offloading 6 DOF processing from the AR glasses 500); operating the AR content generator subsystem 625-2 to generate AR content based on all detected objects as indicated in the received data from the AR glasses 500; and operating the display rendering subsystem 625-3 to generate the image signal for the AR glasses 500 with a resolution of 1280×960 pixels² with a frame rate of 480 Hz.

With regard to the thermal mitigation level ML(1), the corresponding secondary thermal mitigation scheme MST(1) includes operating the AR content generator subsystem 625-2 to reduce AR content by a first level (e.g., ignoring one (1) or 10% of the detected objects for the purpose of generating AR content). The operations of the DSP subsystem 625-1 and the display rendering subsystem 625-3 may be per thermal mitigation level ML(0). As there is less AR content in the image signal or data, the AR glasses 500 performs less processing of the image signal compared to ML(0) to reduce power consumption and heat generation.

Skipping to the thermal mitigation level ML(3), the corresponding secondary thermal mitigation scheme MST(3) includes operating the AR content generator subsystem 625-2 to further reduce AR content by a second level (e.g., ignoring two (2) or 20% of the detected objects for the purpose of generating AR content); and display rendering subsystem 625-3 lowering the resolution and frame rate of the image signal to 640×480 pixels² and 240 Hz. The operation of the DSP subsystem 625-1 may be per thermal mitigation level ML(0). As there is less AR content in the image signal and the resolution and frame rate of the image signal is less, the AR glasses 500 performs less processing of the image signal compared to ML(1) to further reduce power consumption and heat generation.

Skipping to thermal mitigation level ML(5), the corresponding secondary thermal mitigation scheme MST(5) includes operating the DSP subsystem 625-1 to offload, i.e., to take over from the wearable device, at least a portion of the object-pose (6 DOF) processing performed by the AR glasses 500; and the operation of the AR content generator subsystem 625-2 further reduces the AR content by a third level (e.g., ignoring four (4) or 40% of the detected objects for the purpose of generating AR content). The operation of the display rendering subsystem 625-3 may be per thermal mitigation level ML(3). As the DSP subsystem 625-1 has offloaded some 6 DOF processing from the AR glasses 500, and there is less AR content in the image signal, the AR glasses 500 performs less processing of the image signal compared to ML(3) to further reduce power consumption and heat generation.

The other example primary thermal mitigation schemes MST(2) and MST(4) are explained in the Table. It shall be understood that these thermal mitigation schemes are merely examples, and the schemes employed may vary significantly based on the thermal management strategy employed.

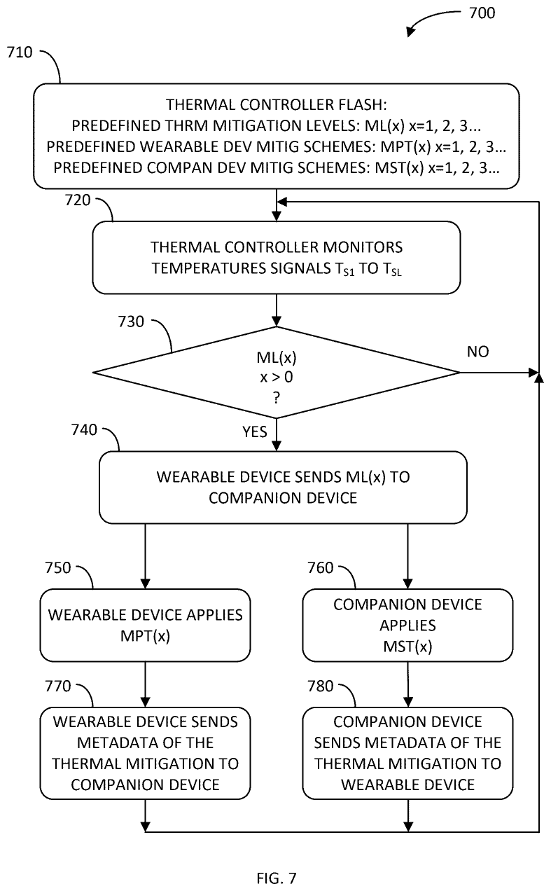

FIG. 7 illustrates a flow diagram of an example method 700 of performing thermal mitigation on behalf of a wearable device by the wearable and companion devices in accordance with another aspect of the disclosure. The method 700 includes a first memory (e.g., a non-volatile memory or flash), which may reside in the wearable device, including a set of predefined thermal mitigation levels ML(x) x=1, 2, 3 . . . , including corresponding sets of thermal mitigation scheme parameters, and a set of predefined primary thermal mitigation schemes MPT(x) x=1, 2, 3 . . . ; and a second memory (e.g., a non-volatile memory or flash), which may reside in the companion device, including a set of predefined secondary thermal mitigation schemes MST(x) x=1, 2, 3 . . . , including corresponding sets of thermal mitigation scheme parameters (block 710).

The method 700 further includes a thermal controller, which may reside in the wearable device, monitoring a set of temperatures T_{S1} to T_{SL} (block 720). As previously discussed, some of the set of temperatures signals T_{S1} to T_{SL} may be generated by skin temperature sensors, e.g., residing in printed circuit boards (PCBs) in the wearable device. Others of the set of temperature signals T_{S1} to T_{SL} may be generated by junction temperature sensors, e.g., residing in one or more integrated circuits (ICs) (e.g., a system on chip (SOC)) of the wearable device). Then, according to the method 700, the thermal controller determines whether thermal mitigation is needed (e.g., whether x of ML(x) is greater than zero(0)) (block 730).

If in block 730, the thermal controller determines that no thermal mitigation is needed (x=0), then the thermal controller continues to monitor the set of temperature signals T_{S1} to T_{SL} per block 720. If, on the other hand, in block 730, the thermal controller determines that thermal mitigation is needed, the wearable device sends the thermal mitigation level ML(x) to the companion device (block 740). Further, the wearable device or thermal controller applies the corresponding primary thermal mitigation scheme MPT(x) (block 750), and the companion device (or its thermal controller) applies the corresponding secondary thermal mitigation scheme MST(x) (block 760).

The method 700 may further include the wearable device sending metadata of the thermal mitigation applied at the wearable device to the companion device (block 770). For example, the metadata may inform the companion device of one or more of the following in accordance with the thermal mitigation applied: that the resolution and FPS of the camera subsystem have been reduced to certain settings, the FPS of the video camera has been reduced to another setting, the FPS and resolution of the display have been reduced to lower settings, and certain subroutines of 6 DOF processing are being offloaded to the companion device. The metadata informs the companion device of the thermal mitigation applied in the wearable device so that the companion device may correlate its thermal mitigation with that of the wearable device. With reference to wearable device 110, the thermal controller 125 may send the metadata to the companion device 150 (e.g., in particular, to its thermal controller 160) via the communication interface 130.

Additionally, the method 700 may further include the companion device sending metadata of the thermal mitigation applied at the companion device to the wearable device (block 780). For example, the metadata may inform the wearable device of one or more of the following in accordance with the thermal mitigation applied: the offloaded subroutines of the 6 DOF processing being performed by the companion device, the number of AR content generated being reduced to a certain level, and the FPS and resolution of the rendered image signal sent to the wearable device have been reduced to lower settings. The metadata informs the wearable device of the thermal mitigation applied in the companion device so that the wearable device may correlate its thermal mitigation with that of the companion device. With reference to companion device 150, the thermal controller 160 may send the metadata to the wearable device 110 (e.g., in particular, to its thermal controller 125) via the communication interface 155. The method 700 may then proceed back to block 720 for the thermal controller to continue monitoring the set of temperature signals T_{S1} to T_{SL}.

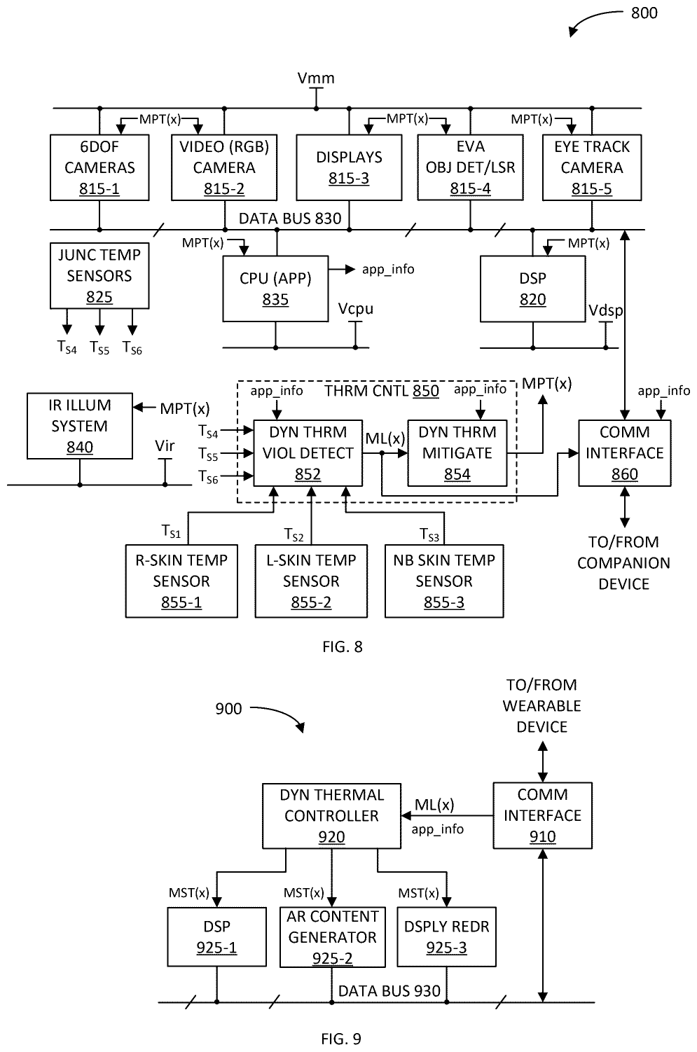

FIG. 8 illustrates a block diagram of another example wearable device 800 in accordance with another aspect of the disclosure. The wearable device 800 is a variation of wearable device 500 previously discussed. In particular, the wearable device 800 includes a 6 DOF camera subsystem 815-1, a video (RGB) camera subsystem 815-2, a display subsystem 815-3, an EVA (object detection and LSR processing) hardware accelerator subsystem 815-4, an eye tracking camera subsystem 815-5, and a DSP subsystem 820, all data coupled together via a data bus 830. The subsystems 815-1 to 815-5 may be coupled to the same power (supply voltage) rail Vmm. The DSP subsystem 820 may be coupled to a different power (supply voltage) rail Vdsp. The operations of the aforementioned subsystems have been previously discussed in detail.

The wearable device 800 may include a set of junction temperature sensors 825 configured to generate a set of temperature signals T_{S4} to T_{S6} (three (3) in this example, but could be more or less) indicative of temperatures of the various subsystems (or cores) of an SOC. The wearable device 800 may also include a central processing unit (CPU) 835 for running user applications programs (e.g., a vehicle driving augmented reality (AR) application program, a sports AR applications program, an educational AR applications program, a gaming AR applications program, etc.). The CPU 835 may be data coupled to the data bus 830. Additionally, the CPU 835 may be coupled to a different power (supply voltage) rail Vcpu. Further, the CPU 835 may be configured to generate information app_info about the current user application being run.

The wearable device 800 further includes an IR illumination subsystem 840 coupled to a different power (supply voltage) rail Vir. The operation of the IR illumination subsystem 840 has been previously discussed in detail. Additionally, the wearable device 800 includes a set of skin temperature sensors 855-1 to 855-3 (three (3) in this example, but could be more or less) configured to generate a set of temperature signals T_{S1} to T_{S3}, respectively. Further, the wearable device 800 includes a communication interface 860 (e.g., Bluetooth, WiFi, USB, cellular, etc.) configured to communicate with a companion device as previously discussed. The communication interface 860 may be coupled to the data bus 830 for receiving data therefrom and providing data thereto.

The wearable device 800 includes a thermal controller 850 including a dynamic thermal violation detection component 852 and a dynamic thermal mitigation component 854. The dynamic thermal violation detection component 852 includes a set of inputs configured to receive the set of skin temperature signals T_{S1} to T_{S3} and the set of junction temperature signals T_{S4} to T_{S6}, respectively. The dynamic thermal violation detection component 852 also includes an input configured to receive the user application information app_info. Accordingly, the dynamic thermal violation detection component 852 is configured to generate a dynamic thermal mitigation level ML(x) based on the temperature signals T_{S1} to T_{S6} and the user application information app_info, as discussed further herein. As shown, the dynamic thermal mitigation level ML(x) may be provided to the communication interface 860 for transmission to the companion device.

The dynamic thermal mitigation component 854, in turn, includes a first input configured to receive the thermal mitigation level ML(x) from the dynamic thermal violation detection component 852 and a second input configured to receive the user application information app_info. The dynamic thermal mitigation component 854 is configured to generate a dynamic primary thermal mitigation scheme MPT(x), as discussed further herein. The dynamic primary thermal mitigation scheme MPT(x) is provided to the various subsystems 815-1 to 815-5, DSP 820, CPU 835, and IR illumination 840. The user application information app_info may be provided to the communication interface 860 for transmission to the companion device.

The dynamic thermal violation detection component 852 may employ machine learning to dynamically generate the thermal mitigation level ML(x) based on the particular application being run by the CPU 835, as well as how the user is interacting with the application, as indicated by the user application information app_info. For example, dynamic thermal violation detection component 852 may give more priority or greater weight to certain of the temperature signals T_{S1} to T_{S6} based on the current application and user activity. For instance, the dynamic thermal violation detection component 852 may decrease or increase the thresholds associated with the temperature signals T_{S1} to T_{S6} in generating the thermal mitigation level ML(x).

Similarly, the dynamic thermal mitigation component 854 may employ machine learning to dynamically generate the primary thermal mitigation scheme MPT(x) based on the particular application being run by the CPU 835, as well as how the user is interacting with the application, as indicated by the user application information app_info. For example, the dynamic thermal mitigation component 854 may learn which one or more subsystems to throttle and how much to throttle them based on the particular application being run by the CPU 835, as well as how the user is interacting with the application. For example, the thermal mitigation may be in a decreasing order of amount of heat each subsystem can mitigate. Additionally, the thermal mitigation may be in an increasing order of impact on user experience. For example, reducing the resolution of the display subsystem 815-3 may have less impact on user experience then disabling one of the displays.

FIG. 9 illustrates a block diagram of another example companion device 900 to the wearable device 800 in accordance with another aspect of the disclosure. The companion device 900 is a variation of companion device 600 previously discussed. In particular, the companion device 900 includes a communication interface 910 (e.g., Bluetooth, WiFi, USB, cellular, etc.), a dynamic thermal controller 920, a DSP (or DPU) subsystem 925-1, an AR content generator 925-2, and a display rendering subsystem 925-3. The companion device 900 further includes a data bus 930 data coupled to the DSP subsystem 925-1, AR content generator subsystem 925-2, display rendering subsystem 925-3, and the communication interface 910.

For dynamic thermal management on behalf of the wearable device 800, the dynamic thermal controller 920 is configured to receive the dynamic thermal mitigation level ML(x) and the user application information app_info from the wearable device 800 via the communication interface 910. The dynamic thermal controller 920 may employ machine learning to generate a dynamic secondary thermal mitigation scheme MST(x) based on the dynamic thermal mitigation level ML(x) and the user application information app_info.

Similarly, the dynamic thermal controller 920 may learn which one or more subsystems to throttle and how much to throttle them based on the particular application being run by the CPU 835, as well as how the user is interacting with the application. For example, the thermal mitigation may be in a decreasing order of amount of heat each subsystem can mitigate. Additionally, the thermal mitigation may be in an increasing order of impact on user experience.

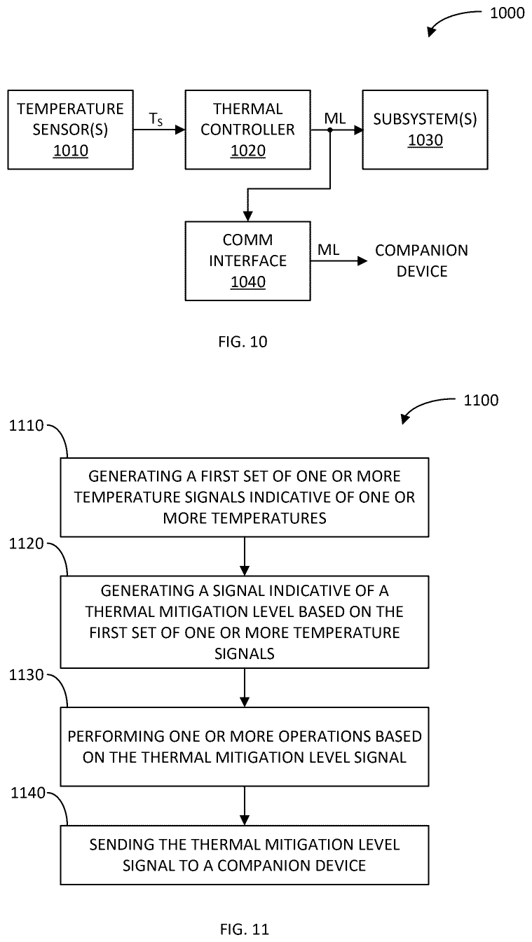

FIG. 10 illustrates a block diagram of another example wearable device 1000 in accordance with another aspect of the disclosure. The wearable device 1000 includes a first set of one or more temperature sensors 1010 configured to generate a first set of one or more temperature signals T_{S} indicative of one or more temperatures. The wearable device 1010 further includes a thermal controller 1020 configured to generate a signal indicative of a thermal mitigation level ML based on the first set of one or more temperature signals T_{S}. Additionally, the wearable device 1000 includes a set of one or more subsystems 1030 configured to perform one or more operations based on the thermal mitigation level signal ML. And, the wearable device 1000 includes a communication interface 1040 configured to send the thermal mitigation level signal ML to a companion device.

FIG. 11 illustrates a flow diagram of an example method 1100 of applying thermal management at a wearable device in accordance with another aspect of the disclosure. The method 1100 includes generating a first set of one or more temperature signals indicative of one or more temperatures (block 1110). The method 1100 further includes generating a signal indicative of a thermal mitigation level based on the first set of one or more temperature signals (block 1120). Additionally, the method 1100 includes performing one or more operations based on the thermal mitigation level signal (block 1130). And, the method 1100 includes sending the thermal mitigation level signal to a companion device (block 1140).

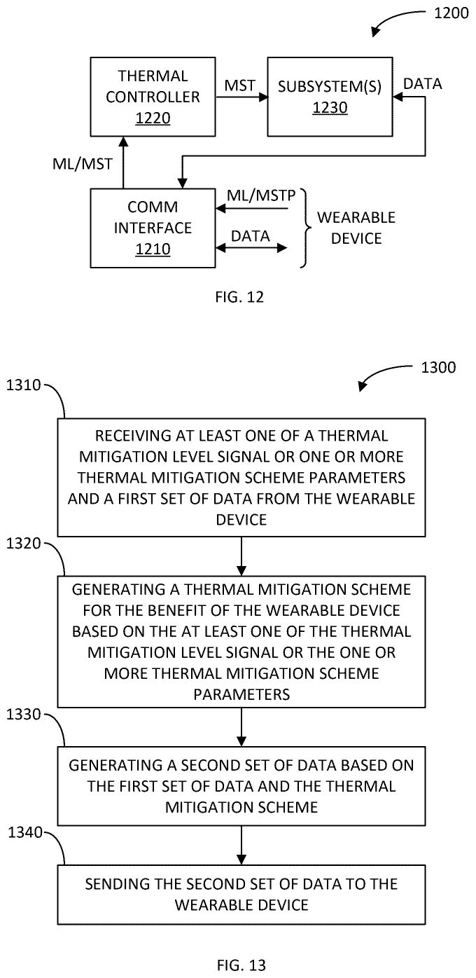

FIG. 12 illustrates a block diagram of another example companion device 1200 to a wearable device in accordance with another aspect of the disclosure. The companion device 1200 includes a communication interface 1210 configured to receive at least one of a thermal mitigation level signal ML or one or more thermal mitigation scheme parameters MST and a first set of data from the wearable device. The companion device 1200 further includes a thermal controller 1220 configured to generate a thermal mitigation scheme MST for a benefit of the wearable device based on the at least one of the thermal mitigation level signal ML or the one or more thermal mitigation scheme parameters MSTP. And, the companion device 1200 includes a first set of one or more subsystems 1230 configured to generate a second set of data based on the first set of data and the thermal mitigation scheme MST, wherein the second set of data is sent to the wearable device via the communication interface 1210.

FIG. 13 illustrates a flow diagram of an example method 1300 of providing thermal management for a benefit of a wearable device in accordance with another aspect of the disclosure. The method 1300 includes receiving at least one of a thermal mitigation level signal or one or more thermal mitigation scheme parameters and a first set of data from the wearable device (block 1310). The method 1300 further includes generating a thermal mitigation scheme for the benefit of the wearable device based on the at least one of the thermal mitigation level signal or the one or more thermal mitigation scheme parameters (block 1320). Additionally, the method 1300 includes generating a second set of data based on the first set of data and the thermal mitigation scheme (block 1330). And, the method 1300 includes sending the second set of data to the wearable device (block 1340).

Some of the components described herein, such as one or more of the subsystems, thermal controllers, and communication interfaces, may be implemented using a processor. A processor, as used herein, may be any dedicated circuit, processor-based hardware, a processing core of a system on chip (SOC), etc. Hardware examples of a processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor may be coupled to memory (e.g., generally a computer-readable media or medium), such as a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

The following provides an overview of aspects of the present disclosure:

Aspect 1: A wearable device comprising: a set of one or more temperature sensors configured to generate a first set of one or more temperature signals indicative of one or more temperatures; a thermal controller configured to generate a signal indicative of a thermal mitigation level based on the first set of one or more temperature signals; a set of one or more subsystems configured to perform one or more operations based on the thermal mitigation level signal; and a communication interface configured to send the thermal mitigation level signal to a companion device.

Aspect 2: The wearable device of aspect 1, wherein the thermal controller is configured to increase the thermal mitigation level to a first mitigation level above an unmitigated level in response to the first set of one or more temperature signals indicating one or more temperatures rising above one or more temperature thresholds.

Aspect 3: The wearable device of aspect 2, wherein the set of one or more subsystems are configured to throttle the one or more operations in response to the thermal mitigation level signal indicating the thermal mitigation level above an unmitigated level, wherein the throttle of the one or more operations correlates with throttling performed by the companion device in response to the thermal mitigation level signal.

Aspect 4: The wearable device of aspect 3, wherein the set of one or more subsystems comprises a camera subsystem, wherein the throttling of the one or more operations of the camera subsystem comprises reducing frames per second (FPS) at which images are captured.

Aspect 5: The wearable device of aspect 3 or 4, wherein the set of one or more subsystems comprises a camera subsystem, wherein the throttling of the one or more operations of the camera subsystem comprises reducing a resolution of images being captured.

Aspect 6: The wearable device of any one of aspects 3-5, wherein the set of one or more subsystems comprises a camera subsystem including a set of cameras, wherein the throttling of the one or more operations of the camera subsystem comprises disabling one or more of the set of cameras.

Aspect 7: The wearable device of any one of aspects 3-6, wherein the set of one or more subsystems comprises a six degrees of freedom (6 DOF) object pose camera subsystem.

Aspect 8: The wearable device of any one of aspects 3-7, wherein the set of one or more subsystems comprises a video camera subsystem, wherein the throttling of the one or more operations of the video camera subsystem comprises reducing frames per second (FPS) at which images are captured.

Aspect 9: The wearable device of any one of aspects 3-8, wherein the set of one or more subsystems comprises a display subsystem, wherein the throttling of the one or more operations of the display subsystem comprises reducing frames per second (FPS) at which images are rendered.

Aspect 10: The wearable device of any one of aspects 3-9, wherein the set of one or more subsystems comprises a display subsystem, wherein the throttling of the one or more operations of the display subsystem comprises reducing a brightness of the display subsystem.

Aspect 11: The wearable device of any one of aspects 3-10, wherein the set of one or more subsystems comprises a display subsystem including a set of displays, wherein the throttling of the one or more operations of the display subsystem comprises disabling one or more of the set of displays.

Aspect 12: The wearable device of any one of aspects 3-11, wherein the set of one or more subsystems comprises an infrared (IR) illumination subsystem, wherein the throttling of the one or more operations of the IR illumination subsystem comprises reducing a brightness of IR emission from the IR illumination subsystem.

Aspect 13: The wearable device of any one of aspects 3-12, wherein the set of one or more subsystems comprises an infrared (IR) illumination subsystem including a set of light emitting diodes (LEDs), wherein the throttling of the one or more operations of the IR illumination subsystem comprises disabling one or more of the set of LEDs.

Aspect 14: The wearable device of any one of aspects 3-11, wherein the set of one or more subsystems comprises an infrared (IR) illumination subsystem, wherein the throttling of the one or more operations of the IR illumination subsystem comprises disabling the IR illumination subsystem.

Aspect 15: The wearable device of any one of aspects 3-14, wherein the set of one or more subsystems comprises a camera subsystem and a digital signal processing (DSP) subsystem, wherein the DSP subsystem is configured to process an image signal received from the camera subsystem, and wherein throttling of the one or more operations comprises offloading at least a portion of the image signal processing to the companion device or hopping at least the portion of the image signal processing between the DSP subsystem and the companion device.

Aspect 16: The wearable device of aspect 15, wherein the image signal processing comprises object-pose six degrees of freedom (6 DOF) image processing.

Aspect 17: The wearable device of any one of aspects 3-16, wherein the set of one or more subsystems comprises a display subsystem, wherein the throttling of the one or more operations of the display subsystem comprises displaying less images due to reduced image data received from the companion device in response the thermal mitigation level signal sent to the companion device.

Aspect 18: The wearable device of any one of aspects 3-17, wherein the set of one or more subsystems comprises a late-stage reprojection (LSR) processing subsystem, wherein the throttling of the one or more operations of the LSR processing subsystem comprises performing less LSR processing due to reduced image data received from the companion device in response the thermal mitigation level signal sent to the companion device.

Aspect 19: The wearable device of any one of aspects 3-18, wherein the thermal controller is configured to send metadata related to the throttling of the one or more operations to the companion device via the communication interface.

Aspect 20: The wearable device of any one of aspects 3-19, wherein the thermal controller is configured to receive metadata, related to throttling of one or more operations at the companion device in response to the thermal mitigation level signal, from the companion device via the communication interface.

Aspect 21: The wearable device of any one of aspects 1-20, wherein the thermal controller is configured to raise the thermal mitigation level to a second thermal mitigation level above the first thermal mitigation level in response to the first set of one or more temperature signals indicating one or more additional temperatures rising above one or more additional temperature thresholds.

Aspect 22: The wearable device of aspect 19, wherein the set of one or more subsystems are configured to apply more throttling of the one or more operations in response to the thermal mitigation level signal indicating the raised thermal mitigation level above the another thermal mitigation level.

Aspect 23: The wearable device of any one of aspects 1-22, wherein the first set of one or more temperature signals are indicative one or more skin temperatures of a user, and further comprising a second set of one or more temperature sensors configured to generate a second set of one or more temperature signals indicative of one or more junction temperatures of an integrated circuit (IC) comprising at least a portion of the set of one or more subsystems.

Aspect 24: The wearable device of aspect 23, wherein the thermal controller is configured to raise the thermal mitigation level to a second thermal mitigation level above the first thermal mitigation level in response to the second set of one or more temperature signals indicating one or more junction temperatures rising above one or more temperature thresholds.

Aspect 25: The wearable device of aspect 24, wherein the set of one or more subsystems are configured to apply more throttling of the one or more operations, as compared to throttling of the one or more operations applied in response to the thermal mitigation level indicating the first mitigation level, in response to the thermal mitigation level signal indicating the second thermal mitigation level.

Aspect 26: The wearable device of any one of aspects 1-25, wherein the set of one or more subsystems comprises a processor configured to run a user application, wherein the thermal controller is configured to dynamically generate the thermal mitigation level based on the first set of one or more temperature signals and information associated with the user application.

Aspect 27: The wearable device of any one of aspects 1-26, wherein the set of one or more subsystems comprises a processor configured to run a user application, wherein the thermal controller is configured to dynamically set a thermal mitigation scheme for the set of one or more subsystems based on the first set of one or more temperature signals and information associated with the user application.

Aspect 28: The wearable device of aspect 27, wherein the set of one or more subsystems are configured to throttle the one or more operations based on the dynamic thermal mitigation scheme.

Aspect 29: The wearable device of aspect 28, wherein the dynamic thermal mitigation scheme is one of a set of dynamic thermal mitigation schemes organized in a decreasing order of amount of thermal each of the set of one or more subsystems can mitigate.

Aspect 30: The wearable device of aspect 28 or 29, wherein the dynamic thermal mitigation scheme is one of a set of dynamic thermal mitigation schemes organized in an increasing order of impact on user experience.

Aspect 31: A method of applying thermal management at a wearable device, comprising: generating a first set of one or more temperature signals indicative of one or more temperatures; generating a signal indicative of a thermal mitigation level based on the first set of one or more temperature signals; performing one or more operations based on the thermal mitigation level signal; and sending the thermal mitigation level signal to a companion device.

Aspect 32: A companion device for a wearable device, including: companion device for a wearable device, including: a communication interface configured to receive at least one of a thermal mitigation level signal or one or more thermal mitigation scheme parameters and a first set of data from the wearable device; a thermal controller configured to generate a thermal mitigation scheme for a benefit of the wearable device based on the at least one of the thermal mitigation level signal or the one or more thermal mitigation scheme parameters; and a first set of one or more subsystems configured to generate a second set of data based on the first set of data and the at least one of the thermal mitigation scheme or the one or more thermal mitigation scheme parameters, wherein the second set of data is sent to the wearable device via the communication interface.

Aspect 33: The companion device of aspect 32, wherein the first set of data comprises image data, wherein the first set of one or more subsystems comprises a digital signal processing (DSP) subsystem, and wherein the DSP subsystem is configured to offload image processing of the first set of data from the wearable device based on the at least one of the thermal mitigation level signal or the one or more thermal mitigation scheme parameters.

Aspect 34: The companion device of aspect 33, wherein the offloaded image processing comprises six degrees of freedom (6 DOF) object pose image processing of the first set of data.

Aspect 35: The companion device of any one of aspects 32-34, wherein the first set of one or more subsystems are configured to throttle one or more operations in response to the at least one of the thermal mitigation level signal or the one or more thermal mitigation scheme parameters.

Aspect 36: The companion device of aspect 35, wherein the first set of data comprises image data related to a set of objects, wherein the first set of one or more subsystems comprises a augmented reality (AR) content generator subsystem configured to generate AR content based on the first set of data, and wherein the throttling the one or more operations of the AR content generator subsystem comprises ignoring one or more of the set of objects in the image data.

Aspect 37: The companion device of aspect 36, wherein the image data related to the set of objects comprises six degrees of freedom (6 DOF) pose data of the set of objects.

Aspect 38: The companion device of any one of aspects 35-37, wherein the first set of one or more subsystems comprises a display rendering subsystem configured to generate the second set of data as image data for displaying at the wearable device, wherein the throttling of the one or more operations of the display rendering subsystem comprises reducing frames per second of the image data to be rendered at the wearable device.

Aspect 39: The companion device of any one of aspects 35-38, wherein the thermal controller is configured to send metadata related to the throttling of the one or more operations to the wearable device via the communication interface.

Aspect 40: The companion device of any one of aspects 35-39, wherein the thermal controller is configured to receive metadata, related to throttling of one or more operations at the wearable device associated with the thermal mitigation level signal, from the wearable device via the communication interface.

Aspect 41: The companion device of any one of aspects 32-40, wherein the thermal controller is configured to: receive user application information from the wearable device via the communication interface; and dynamically generate the thermal mitigation scheme further based on the user application information.

Aspect 42: The companion device of aspect 41, wherein the dynamic thermal mitigation scheme is one of a set of dynamic thermal mitigation schemes organized in a decreasing order of amount of heat each of a second set of one or more subsystems in the wearable device can mitigate.

Aspect 43: The companion device of aspect 41 or 42, wherein the dynamic thermal mitigation scheme is one of a set of dynamic thermal mitigation schemes organized in an increasing order of impact on user experience.

Aspect 44: A method providing thermal management for a benefit of a wearable device, including: receiving at least one of a thermal mitigation level signal or one or more thermal mitigation scheme parameters and a first set of data from the wearable device; generating a thermal mitigation scheme for the benefit of the wearable device based on the at least one of the thermal mitigation level signal or the one or more thermal mitigation scheme parameters; generating a second set of data based on the first set of data and the thermal mitigation scheme; and sending the second set of data to the wearable device

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples described herein but is to be accorded the widest scope consistent with the principles and novel features disclosed herein.

What is claimed:

1. A wearable device, comprising:
a first set of one or more temperature sensors configured to generate a first set of one or more temperature signals indicative of one or more temperatures;
a thermal controller configured to generate a signal indicative of a thermal mitigation level based on the first set of one or more temperature signals;
a set of one or more subsystems configured to perform one or more operations based on the thermal mitigation level signal; and
a communication interface configured to send the thermal mitigation level signal to a companion device.

2. The wearable device of claim 1, wherein the thermal controller is configured to set the thermal mitigation level to a first mitigation level above an unmitigated level in response to the first set of one or more temperature signals indicating one or more temperatures rising above one or more temperature thresholds.

3. The wearable device of claim 2, wherein the set of one or more subsystems are configured to throttle the one or more operations in response to the thermal mitigation level signal indicating the thermal mitigation level above an unmitigated level, wherein the throttle of the one or more operations correlates with throttling performed by the companion device in response to the thermal mitigation level signal.

4. The wearable device of claim 3, wherein the set of one or more subsystems comprises a camera subsystem, wherein the throttling of the one or more operations of the camera subsystem comprises reducing frames per second (FPS) at which images are captured.

5. The wearable device of claim 3, wherein the set of one or more subsystems comprises a camera subsystem, wherein the throttling of the one or more operations of the camera subsystem comprises reducing a resolution of images being captured.

6. The wearable device of claim 3, wherein the set of one or more subsystems comprises a camera subsystem including a set of cameras, wherein the throttling of the one or more operations of the camera subsystem comprises disabling one or more of the set of cameras.

7. The wearable device of claim 3, wherein the set of one or more subsystems comprises a six degrees of freedom (6 DOF) object pose camera subsystem.

8. The wearable device of claim 3, wherein the set of one or more subsystems comprises a video camera subsystem, wherein the throttling of the one or more operations of the video camera subsystem comprises reducing frames per second (FPS) at which images are captured.

9. The wearable device of claim 3, wherein the set of one or more subsystems comprises a display subsystem, wherein the throttling of the one or more operations of the display subsystem comprises reducing frames per second (FPS) at which images are rendered.

10. The wearable device of claim 3, wherein the set of one or more subsystems comprises a display subsystem, wherein the throttling of the one or more operations of the display subsystem comprises reducing a brightness of the display subsystem.

11. The wearable device of claim 3, wherein the set of one or more subsystems comprises a display subsystem including a set of displays, wherein the throttling of the one or more operations of the display subsystem comprises disabling one or more of the set of displays.

12. The wearable device of claim 3, wherein the set of one or more subsystems comprises an infrared (IR) illumination subsystem, wherein the throttling of the one or more operations of the IR illumination subsystem comprises reducing a brightness of IR emission from the IR illumination subsystem.

13. The wearable device of claim 3, wherein the set of one or more subsystems comprises an infrared (IR) illumination subsystem including a set of light emitting diodes (LEDs), wherein the throttling of the one or more operations of the IR illumination subsystem comprises disabling one or more of the set of LEDs.

14. The wearable device of claim 3, wherein the set of one or more subsystems comprises an infrared (IR) illumination subsystem, wherein the throttling of the one or more operations of the IR illumination subsystem comprises disabling the IR illumination subsystem.

15. The wearable device of claim 3, wherein the set of one or more subsystems comprises a camera subsystem and a digital signal processing (DSP) subsystem, wherein the DSP subsystem is configured to process an image signal received from the camera subsystem, and wherein throttling of the one or more operations comprises offloading at least a portion of the image signal processing to the companion device or hopping at least the portion of the image signal processing between the DSP subsystem and the companion device.

16. The wearable device of claim 15, wherein the image signal processing comprises object-pose six degrees of freedom (6 DOF) image processing.

17. The wearable device of claim 3, wherein the set of one or more subsystems comprises a display subsystem, wherein the throttling of the one or more operations of the display subsystem comprises displaying less images due to reduced image data received from the companion device in response to the thermal mitigation level signal sent to the companion device.

18. The wearable device of claim 3, wherein the set of one or more subsystems comprises a late-stage reprojection (LSR) processing subsystem, wherein the throttling of the one or more operations of the LSR processing subsystem comprises performing less LSR processing due to reduced image data received from the companion device in response the thermal mitigation level signal sent to the companion device.

19. The wearable device of claim 3, wherein the thermal controller is configured to send metadata related to the throttling of the one or more operations to the companion device via the communication interface.

20. The wearable device of claim 3, wherein the thermal controller is configured to receive metadata, related to throttling of one or more operations at the companion device in response to the thermal mitigation level signal, from the companion device via the communication interface.

21. The wearable device of claim 2, wherein the thermal controller is configured to raise the thermal mitigation level to a second thermal mitigation level above the first mitigation level in response to the first set of one or more temperature signals indicating one or more additional temperatures rising above one or more additional temperature thresholds.

22. The wearable device of claim 21, wherein the set of one or more subsystems are configured to apply more throttling of the one or more operations, as compared to throttling of the one or more operations applied in response to the thermal mitigation level indicating the first mitigation level, in response to the thermal mitigation level signal indicating the second thermal mitigation level.

23. The wearable device of claim 2, wherein the first set of one or more temperature signals are indicative one or more skin temperatures of a user, and further comprising a second set of one or more temperature sensors configured to generate a second set of one or more temperature signals indicative of one or more junction temperatures of an integrated circuit (IC) comprising at least a portion of the set of one or more subsystems.

24. The wearable device of claim 23, wherein the thermal controller is configured to raise the thermal mitigation level to a second thermal mitigation level above the first mitigation level in response to the second set of one or more temperature signals indicating one or more junction temperatures rising above one or more temperature thresholds.

25. The wearable device of claim 24, wherein the set of one or more subsystems are configured to apply more throttling of the one or more operations, as compared to throttling of the one or more operations applied in response to the thermal mitigation level indicating the first mitigation level, in response to the thermal mitigation level signal indicating the second thermal mitigation level.

26. The wearable device of claim 1, wherein the set of one or more subsystems comprises a processor configured to run a user application, wherein the thermal controller is configured to dynamically generate the thermal mitigation level based on the first set of one or more temperature signals and information associated with the user application.

27. The wearable device of claim 1, wherein the set of one or more subsystems comprises a processor configured to run a user application, wherein the thermal controller is configured to dynamically set a thermal mitigation scheme for the set of one or more subsystems based on the first set of one or more temperature signals and information associated with the user application.

28. The wearable device of claim 27, wherein the set of one or more subsystems are configured to throttle the one or more operations based on the dynamic thermal mitigation scheme.

29. The wearable device of claim 28, wherein the dynamic thermal mitigation scheme is one of a set of dynamic thermal mitigation schemes organized in a decreasing order of amount of thermal each of the set of one or more subsystems can mitigate.

30. The wearable device of claim 28, wherein the dynamic thermal mitigation scheme is one of a set of dynamic thermal mitigation schemes organized in an increasing order of impact on user experience.

31. A method of applying thermal management at a wearable device, comprising:
generating a first set of one or more temperature signals indicative of one or more temperatures;
generating a signal indicative of a thermal mitigation level based on the first set of one or more temperature signals;
performing one or more operations based on the thermal mitigation level signal; and
sending the thermal mitigation level signal to a companion device.

32. A companion device for a wearable device, comprising:
a communication interface configured to receive at least one of a thermal mitigation level signal or one or more thermal mitigation scheme parameters and a first set of data from the wearable device;
a thermal controller configured to generate a thermal mitigation scheme for a benefit of the wearable device based on the at least one of the thermal mitigation level signal or the one or more thermal mitigation scheme parameters; and
a first set of one or more subsystems configured to generate a second set of data based on the first set of data and the thermal mitigation scheme, wherein the second set of data is sent to the wearable device via the communication interface.

33. The companion device of claim 32, wherein the first set of data comprises image data, wherein the first set of one or more subsystems comprises a digital signal processing (DSP) subsystem, and wherein the DSP subsystem is configured to offload image processing of the first set of data from the wearable device based on the at least one of the thermal mitigation level signal or the one or more thermal mitigation scheme parameters.

34. The companion device of claim 33, wherein the offloaded image processing comprises six degrees of freedom (6 DOF) object pose image processing of the first set of data.

35. The companion device of claim 32, wherein the first set of one or more subsystems are configured to throttle one or more operations in response to the at least one of the thermal mitigation level signal or the one or more thermal mitigation scheme parameters.

36. The companion device of claim 35, wherein the first set of data comprises image data related to a set of objects, wherein the first set of one or more subsystems comprises an augmented reality (AR) content generator subsystem configured to generate AR content based on the first set of data, and wherein the throttling of the one or more operations of the AR content generator subsystem comprises ignoring one or more of the set of objects in the image data.

37. The companion device of claim 36, wherein the image data related to the set of objects comprises six degrees of freedom (6 DOF) pose data of the set of objects.

38. The companion device of claim 35, wherein the first set of one or more subsystems comprises a display rendering subsystem configured to generate the second set of data as image data for displaying at the wearable device, wherein the throttling of the one or more operations of the display rendering subsystem comprises reducing frames per second of the image data to be rendered at the wearable device.

39. The companion device of claim 35, wherein the thermal controller is configured to send metadata related to the throttling of the one or more operations to the wearable device via the communication interface.

40. The companion device of claim 35, wherein the thermal controller is configured to receive metadata, related to throttling of one or more operations at the wearable device associated with the thermal mitigation level signal, from the wearable device via the communication interface.

41. The companion device of claim 32, wherein the thermal controller is configured to:
receive user application information from the wearable device via the communication interface; and
dynamically generate the thermal mitigation scheme further based on the user application information.

42. The companion device of claim 41, wherein the dynamic thermal mitigation scheme is based on one of a set of dynamic thermal mitigation schemes organized in a decreasing order of amount of heat each of a second set of one or more subsystems in the wearable device can mitigate.

43. The companion device of claim 41, wherein the dynamic thermal mitigation scheme is based on one of a set of dynamic thermal mitigation schemes organized in an increasing order of impact on user experience.

44. A method of providing thermal management for a benefit of a wearable device, comprising:
receiving at least one of a thermal mitigation level signal or one or more thermal mitigation scheme parameters and a first set of data from the wearable device;
generating a thermal mitigation scheme for the benefit of the wearable device based on the at least one of the thermal mitigation level signal or the one or more thermal mitigation scheme parameters;
generating a second set of data based on the first set of data and the thermal mitigation scheme; and
sending the second set of data to the wearable device.
